(19) United States
(12) Patent Application Publication
(10) Pub. No.: US 2024/0243401 A1
(43) Pub. Date: Jul. 18, 2024

(54) METHOD FOR MANUFACTURING ELECTRICAL STORAGE DEVICE

(71) Applicants: Prime Planet Energy & Solutions, Inc., Tokyo (JP); TOYOTA JIDOSHA KABUSHIKI KAISHA, Aichi-ken (JP); PRIMEARTH EV ENERGY CO., LTD., Shizuoka-ken (JP)

(72) Inventors: Yuki SATO, Toyota-shi (JP); Yozo UCHIDA, Toyota-shi (JP); Tsuyoshi EHARA, Toyota-shi (JP); Syoichi TSUCHIYA, Toyota-shi (JP); Masataka ASAI, Toyota-shi (JP); Nozomi TATEYAMA, Okazaki-shi (JP); Tsuyoshi ASANO, Toyota-shi (JP); Masahiro UCHIMURA, Miyoshi-shi (JP); Shigeru MATSUMOTO, Toyohashi-shi (JP); Daisuke SUZUKI, Hamamatsu-shi (JP); Yuki NAGAE, Toyohashi-shi (JP)

(21) Appl. No.: 18/510,653

(22) Filed: Nov. 16, 2023

(30) Foreign Application Priority Data
Jan. 13, 2023 (JP) 2023-003660

(51) Int. Cl. H01M 50/169; B23K 26/24; H01M 50/103; H01M 50/15; H01M 50/176; H01M 50/588; H01M 50/593

(52) U.S. Cl. CPC H01M 50/169; B23K 26/24; H01M 50/103; H01M 50/15; H01M 50/176; H01M 50/588; H01M 50/593

(57) ABSTRACT

The manufacture method disclosed herein is a method for manufacturing an electrical storage device, including a step of preparing an outer case in which a peripheral part of an opening is a flat surface, and a lid assembly obtained by integral molding of a lid, a terminal member and an insulating member, a step of attaching the lid assembly to the opening of the outer case, and a step of irradiating the boundary of the peripheral part and an outer edge part with laser light. The lid assembly is placed so that an inclined part will become thinner from the outer surface toward the boundary with the outer case, and the outer surface of the lid is placed at a higher place than the peripheral part of the opening, and the inner surface of the lid is placed at a lower place than the peripheral part of the opening.

### CROSS REFERENCE TO RELATED APPLICATION

The present application claims the priority based on Japanese Patent Application No. 2023-003660 filed on Jan. 13, 2023, the entire contents of which are incorporated in the present specification by reference.

### BACKGROUND OF THE DISCLOSURE

### 1. Field

The present disclosure relates to a method for manufacturing an electrical storage device.

### 2. Background

Batteries, including an electrode body, an outer case to house the electrode body, a lid which seals the opening of the outer case and has terminal attachment holes, and terminal members attached to the terminal attachment holes of the lid, have been known in the past. The outer case and the lid are sealed, for example, by welding such as laser welding.

Japanese Unexamined Patent Application Publication No. 7-183012, for example, describes that an outer can having an opening end face, which is inclined from a terminal member to the outward and downward directions, and a lid are welded. Japanese Unexamined Patent Application Publication No. 2010-97770 discloses that laser welding is performed on a battery housing, which has a step to which a lid can be fixed onto the inner wall of the opening, and when the lid is fixed onto the step, the place of the upper surface of the lid is higher than the upper end of the opening. Japanese Unexamined Patent Application Publication No. 11-213967 describes that a terminal is attached to a metal lid through a gasket, the lid is fitted at a higher place than the upper end face of a metal case, and laser welding is performed. WO2015/072010 also describes that a lateral boundary surface (Fx) in the lateral direction intersecting the height direction of a side wall part, and a longitudinal boundary surface (Fy) in the longitudinal direction intersecting the lateral boundary surface and along the height direction of the side wall part are formed between the battery can and the battery lid, and at least part of the lateral boundary surface and at least part of the longitudinal boundary surface are welded by laser (EB) irradiation in the longitudinal direction along the height direction of the side wall part.

### SUMMARY

In recent years, a lid assembly in which a lid, a terminal member and a resin insulating member are integrally molded, has been used in batteries having high energy density. In such lid assembly, the space between an outer edge part of the lid and the insulating member tends to be narrow from the viewpoint of improvements in adhesion strength and the like. When the techniques disclosed in Japanese Unexamined Patent Application Publication No. 7-183012, Japanese Unexamined Patent Application Publication No. 2010-97770, Japanese Unexamined Patent Application Publication No. 11-213967 and WO2015/072010 are applied for welding joint of the lid assembly as described above and an outer case, because a site for laser welding and the resin insulating member are close to each other, the insulating member can be burned. Consequently, the insulating member is deteriorated, and reductions in insulating properties and reductions in airtightness of batteries can be caused.

As disclosed in Japanese Unexamined Patent Application Publication No. 7-183012, for example, when inclination is provided for the opening end face of the outer can, the area irradiated with laser light is small and the amount of metal melted is lessened. Therefore, there has been room for improvement also from the viewpoint of welding strength.

The present disclosure has been made in view of such points, and an object thereof is to provide a manufacture method in which at the time of laser welding of a lid assembly obtained by integral molding of a lid, a terminal member and a resin insulating member, and an outer case, deterioration of the insulating member is suppressed and a battery having high welding strength is achieved.

The manufacture method disclosed herein is a method for manufacturing an electrical storage device, including a case including an outer case having an opening on one side surface and the bottom, and a lid having terminal attachment holes and sealing the opening; an electrode body accommodated in the case; a terminal member having one end electrically connected to the electrode body in the inside of the case and the other end exposed to the outside of the lid; and a resin insulating member, which insulates a surface of the lid, which is the outer surface on the outside of the case, the opening of which is sealed, from the terminal member. The manufacture method includes a step of preparing the outer case in which a peripheral part of the opening is a flat surface, and a lid assembly obtained by integral molding of the lid, the terminal member and the insulating member; a step of attaching the lid assembly to the opening of the outer case; and a step of laser welding of the outer case and the lid assembly by irradiating the boundary between the peripheral part of the opening and the outer edge part of the lid with laser light from the outer surface side of the lid. The lid of the lid assembly prepared in the preparation step has an inclined part, which becomes thinner from the middle side toward the outer edge part of the lid, in a region in which the outer edge part of the lid and the insulating member are closest to each other. In the attachment step, the lid assembly is placed so that the inclined part will become thinner from the outer surface toward the boundary with the outer case, and the outer surface of the lid is placed at a higher place than the peripheral part of the opening, and the inner surface of the lid is placed at a lower place than the peripheral part of the opening.

According to such a structure, irradiated laser light from the outside of the lid is reflected on the inclined part and easily reflected in a direction that moves away from the insulating member. Therefore, even when the insulating member and the outer edge part of the lid are close to each other, burns of the insulating member can be suppressed. Because the peripheral part of the opening of the outer case is a flat surface, the area irradiated with laser light is increased, and the amount of metal melted therein can be increased. Because of this, welding strength can be raised. Therefore, deterioration of the insulating member is suppressed, and a battery having high welding strength can be achieved.

### BRIEF DESCRIPTION OF THE DRAWINGS

FIG. 1 is a perspective view schematically showing a battery according to one embodiment;

FIG. 2 is an exploded perspective view of a battery according to one embodiment;

FIG. 3 is a planar view of a lid;

FIG. 4 is a schematic longitudinal sectional view taken along the line IV-IV in FIG. 1;

FIG. 5 is a longitudinal sectional view schematically showing a boundary part between the lid and an outer case in a welding step; and

FIG. 6 is a schematic longitudinal sectional view describing a conventional welding step for batteries.

### DETAILED DESCRIPTION OF THE PREFERRED EMBODIMENTS

Embodiments of the technique disclosed herein will now be described with reference to drawings. It should be noted that things other than matters particularly mentioned in the specification, which things are necessary to implement the technique disclosed herein (for example, general structures and production processes for batteries which do not characterize the technique disclosed herein) can be understood as design matters of those skilled in the art based on conventional techniques in the art. The technique disclosed herein can be implemented based on the contents disclosed in the specification and technical knowledge in the art.

The “electrical storage device” in the specification indicates a device in which charge and discharge reactions occur by the movement of a charge carrier between a pair of electrodes (positive electrode and negative electrode) via an electrolyte.

Such an electrical storage device encompasses secondary batteries such as lithium ion secondary batteries, nickel metal hydride batteries and nickel cadmium batteries; and capacitors such as lithium ion capacitors and electric double-layer capacitors.

One embodiment of the technique disclosed herein will now be described using a lithium ion secondary battery among the above-described electrical storage devices as an example of the electrical storage device manufactured by the manufacture method disclosed herein. First, the structure of the lithium ion secondary battery will now be described, and the manufacture method disclosed herein will be then described.

### Battery 100

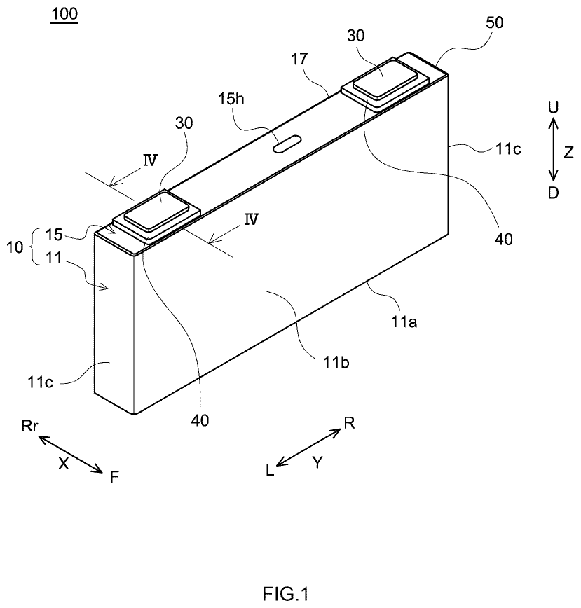

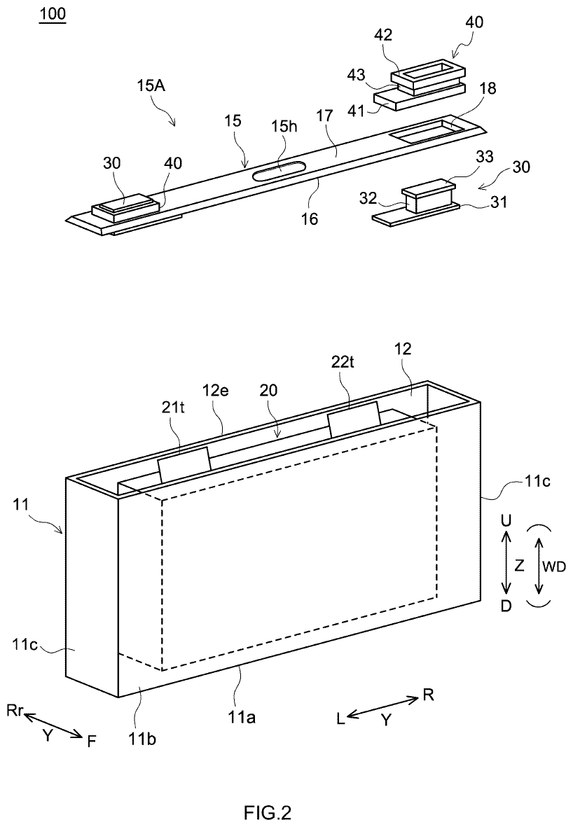

FIG. 1 is a perspective view of a battery 100. FIG. 2 is an exploded perspective view describing the structure of the battery 100. In the following description, signs L, R, F, Rr, U and D in the diagrams represent left, right, front, rear, upside and downside, respectively. The sign X in the diagrams shows “the short side direction of the battery,” the sign Y shows “the long side direction of the battery” and the sign Z shows “the vertical direction of the battery.” However, these are only directions for convenient explanation, and do not limit the setting forms of the battery 100 in any way.

As shown in FIG. 1 and FIG. 2, the battery 100 includes a case 10, an electrode body 20, a terminal member 30 and an insulating member 40. The battery 100 further includes an electrolyte solution not shown here. The battery 100 includes an assembly part obtained by integral molding of a lid 15, the terminal member 30 and the insulating member 40 (hereinafter also referred to as “lid assembly 15A”). It should be noted that FIG. 2 shows the lid assembly 15A and other parts, which are separated. Furthermore, FIG. 2 shows, regarding an electrode on one side (the right side in FIG. 2), the lid 15, the terminal member 30 and the insulating member 40, which are separated.

The case 10 includes the outer case 11 and the lid 15. As shown in FIG. 1, the case 10 has the external shape of a flat cuboid (square shape) here. The material of the case 10 may be the same as those which have been conventionally used, and is not particularly restricted. The case 10 (the outer case 11 and the lid 15) includes aluminum, an aluminum alloy, stainless steel, iron, an iron alloy or the like. The case 10 is made of aluminum here.

As shown in FIG. 2, the outer case 11 is a housing to house the electrode body 20 and the electrolyte solution. The outer case 11 is a square container having an opening 12 on one side surface (the upper surface here) and the bottom. The opening 12 has an almost rectangular shape here. As shown in FIG. 1, the outer case 11 includes a rectangular bottom surface 11a having the long side and the short side, a pair of long side walls 11b extended from the long side of the bottom surface 11a towards the upper side and facing each other, and a pair of short side walls 11c extended from the short side of the bottom surface 11a toward the upper side and facing each other. The long side wall 11b is an example of first side walls, and the short side wall 11c is an example of second side walls.

It should be noted that the outer case is not particularly limited as long as it is a container having an opening on one side surface and the bottom. The outer case may be, for example, a cylindrical case having the bottom.

The lid 15 has a rectangular shape here, and is a plate-shaped member to seal the opening 12 of the outer case 11. The exterior shape of the lid 15 is smaller than the opening 12 of the outer case 11. The lid 15 faces the bottom surface 11a of the outer case 11. The lid 15 has an inner surface 16 directed toward the inner side of the battery 100 (i.e. the side facing the electrode body 20), and an outer surface 17 directed toward the outer side of the battery 100. The lid 15 has two terminal attachment holes 18 penetrating the inner surface 16 and the outer surface 17. The terminal attachment hole 18 is provided on each of both ends of the lid 15 in the long side direction Y. The terminal attachment hole 18 on one side (the left side in FIG. 2) is for the positive electrode, and the terminal attachment hole 18 on the other side (the right side in FIG. 2) is for the negative electrode. The average thickness (average plate thickness) of the lid 15 is appropriately 0.3 mm or more, preferably for example 0.5 mm or more from the viewpoint of durability and the like. In addition, the average thickness of the lid 15 is appropriately 2 mm or less, preferably for example 1.5 mm or less from the viewpoint of costs and energy density.

As shown in FIG. 1, an injection hole (not shown) and a gas release vent 15h are provided in the lid 15. The injection hole is a through hole to inject the electrolyte solution into the inside of the case 10 after assembling the lid 15 to the outer case 11. The injection hole is sealed with a sealing member (not shown) after injecting the electrolyte solution. The gas release vent 15h is a thin-walled part formed to be broken when the pressure in the case 10 reaches a predetermined value or more to release gas in the case 10 to the outside.

The lid assembly 15A is an integrally molded member of the lid 15 having the terminal attachment hole 18, the terminal member 30 and the insulating member 40. The lid assembly 15A is attached to close the opening 12 of the outer case 11. Specifically, the inner wall 11d of the side wall of the outer case 11 and the side surface of the lid 15 are joined. As described below, the welding step is performed on the lid assembly 15A with the outer surface 17 of the lid 15 placed at a higher place than the peripheral part 12e of the opening 12, and the inner surface 16 placed at a lower place than the peripheral part 12e of the opening 12. The case 10 is sealed by welding joint with the opening 12 of the outer case 11 closed without a gap by the lid 15. A welded part 50 formed by welding is formed in a predetermined region including part of the boundary of the lid assembly 15A and the outer case 11 (i.e., facing surfaces of both the members).

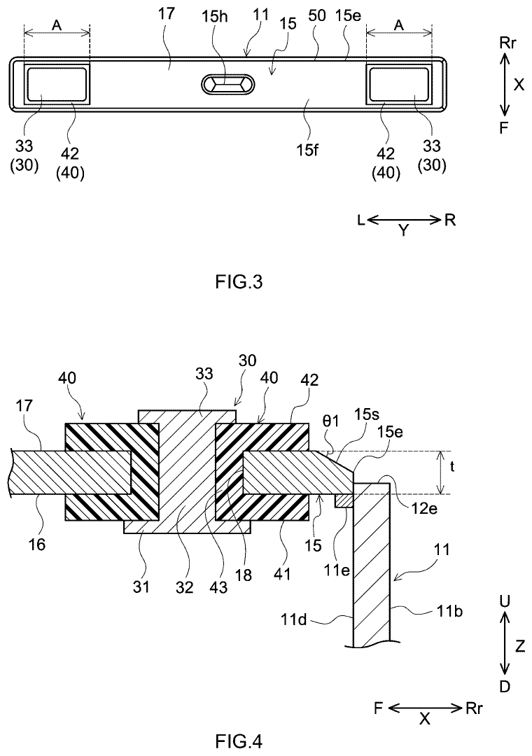

FIG. 3 is a planar view when FIG. 1 is viewed from the upper surface side. As shown in FIG. 3, the welded part 50 is located on the outer surface 17 side of the lid 15. The welded part 50 is continuously formed into an almost circle along the boundary of the outer case 11 and the outer edge part 15e of the lid 15 in a planar view. As shown in FIG. 3, the terminal member 30 and the insulating member 40 are provided on each of both ends in the long side direction Y here. Therefore, the welded part 50 is close to the insulating member 40 on both the ends in the long side direction Y. The welded part 50 is closest to the insulating member 40 in regions A on both ends in the long side direction Y here. The region A is a range having a length almost equal to the length of the insulating member 40 in the long side direction Y (errors of about ±1 mm are accepted). The region A is an example of “a region in which the outer edge part of the lid and the insulating member are closest to each other.” In the region A, the distance between the welded part 50 and the insulating member 40 is not particularly limited, and may be appropriately 5 mm or less, for example 3 mm or less. In the region A, the distance between the welded part 50 and the insulating member 40 is not particularly limited, and may be 1 mm to 2 mm.

FIG. 4 is a cross-sectional view taken along the line IV-IV in FIG. 1. It should be noted that in FIG. 4, only the long side wall 11b on one side of the outer case 11 is shown, and the other long side wall 11b is omitted. As shown in FIG. 4, the outer case 11 may also include a supporting part 11e, projecting from the inner wall 11d to the inside of the case. The supporting part 11e is a part to place the lid 15 at a desired place. When the lid 15 is put on the supporting part 11e, for example, welding can be performed with the outer surface 17 of the lid 15 placed at a higher place than the peripheral part 12e of the opening 12, and the inner surface 16 of the lid 15 placed at a lower place than the peripheral part 12e of the opening 12. The supporting part 11e may be provided around the whole circumference of the opening 12 of the outer case 11, or may be provided only on the inner surface of the short side wall 11c. Alternatively, the supporting part 11e may be also provided at 4 angles of the outer case 11.

The electrode body 20 is accommodated in the inside of the outer case 11. The electrode body 20 is covered with a resin insulation film (not shown) or the like, and accommodated in the outer case 11. The electrode body 20 includes a positive electrode sheet, a negative electrode sheet and a separator sheet placed between the positive electrode sheet and the negative electrode sheet. The electrode body 20 here is a wound electrode body, in which a strip-shaped positive electrode sheet and a strip-shaped negative electrode sheet are laminated via two strip-shaped separator sheets with the electrode sheets insulated, and they are wound onto the winding axis in the longitudinal direction. However, the electrode body 20 may be also a laminate electrode body obtained by laminating a quadrilateral positive electrode and a quadrilateral negative electrode with the electrodes insulated. It should be noted that the sign WD in FIG. 2 shows the winding axis direction of the electrode body 20 (also the width direction).

The positive electrode sheet is a member in which a positive active material layer including a positive active material is placed on at least one surface of a positive current collector (for example, aluminum foil). The structure of the positive electrode sheet is not particularly limited and may be the same as those which have been used for conventionally known batteries. As the positive active material, conventionally known materials can be used without particular restrictions. As an example, lithium transition metal composite oxide is provided. The negative electrode sheet is a member in which a negative active material layer including a negative active material is placed on at least one surface of a negative current collector (for example, copper foil). The structure of the negative electrode sheet is not particularly limited and may be the same as those which have been used for conventionally known batteries. As the negative active material, conventionally known materials can be used without particular restrictions. As an example, a carbon material such as graphite is provided. The separator sheet is a resin sheet with insulating properties, having a plurality of fine through holes through which a charge carrier can pass. The structure of the separator sheet is not particularly limited, and may be the same as those which have been used for conventionally known batteries.

The electrode body 20 is accommodated in the inside of the outer case 11 so that the winding axis direction WD will be almost equal to the vertical direction Z. In other words, the electrode body 20 is placed in the inside of the case 10 in a direction in which the winding axis direction WD is almost parallel to the long side wall 11b and the short side wall 11c, and almost intersects the bottom surface 11a and the lid 15.

The positive electrode sheet has a plurality of positive electrode tabs 21t projecting from one edge of the winding axis direction WD to the outside (the upper side in FIG. 2). The positive electrode tab 21t is a region in which the positive active material layer is not formed. The negative electrode sheet also has a plurality of negative electrode tabs 22t projecting from one edge of the winding axis direction WD to the outside (the upper side in FIG. 2). It should be noted that although a separated state is shown in FIG. 2, the terminal members 30 are each electrically joined to the positive electrode sheet and the negative electrode sheet in a finished product of the battery 100.

As shown in FIG. 1 and FIG. 2, the terminal members 30 are each provided on both ends of the lid 15 in the long side direction Y. As shown in FIG. 2, one end is placed in the inside of the case 10, and the other end is inserted into the terminal attachment hole 18 and placed in the outside of the lid 15. The terminal member 30 on the positive electrode side includes, for example, aluminum or an aluminum alloy. The terminal member 30 on the negative electrode side includes, for example, copper or a copper alloy.

As shown in FIG. 2 and FIG. 4, the terminal member 30 has an electrode body connecting part 31, a shaft part 32 and an outside connecting part 33. The electrode body connecting part 31 is placed in the inside of the case 10. As shown in FIG. 2, the electrode body connecting part 31 is formed into a quadrilateral flat plate shape here, and is extended in the horizonal direction along the inner surface 16 of the lid 15. The end of the electrode body connecting part 31 in the long side direction Y is electrically connected to the positive electrode tab 21t or the negative electrode tab 22t of the electrode body 20 in the inside of the case 10.

The shaft part 32 is placed between the electrode body connecting part 31 and the outside connecting part 33, and inserted into the terminal attachment hole 18. The shaft part 32 is extended from the electrode body connecting part 31 toward the upper side. The outside connecting part 33 is placed to be exposed to the outer surface 17 of the case 10. The outside connecting part 33 is provided on the upper side of the shaft part 32. The outside connecting part 33 is formed to have a size which can be inserted into the terminal attachment hole 18. The shaft part 32 is constricted compared to the electrode body connecting part 31 and the outside connecting part 33 due to differences in the size of the electrode body connecting part 31, the shaft part 32 and the outside connecting part 33.

The insulating member 40 is a resin member to prevent conduction between the lid 15 and the terminal member 30. The insulating member 40 is preferably formed, for example, from a fluororesin such as perfluoroalkoxyalkane (PFA) or polytetrafluoroethylene (PTFE), or a synthetic resin material such as polyphenylene sulfide (PPS). An inorganic filler, for example, may be added to the synthetic resin material. As shown in FIG. 4, the insulating member 40 has a first flange part 41, a second flange part 42 and a tubular part 43. The first flange part 41, the second flange part 42 and the tubular part 43 are integrally formed here.

The tubular part 43 is located between the terminal attachment hole 18 and the shaft part 32 of the terminal member 30. The tubular part 43 insulates the terminal attachment hole 18 from the shaft part 32. The first flange part 41 is extended in the horizonal direction along the inner surface 16 of the lid 15. The first flange part 41 insulates the inner surface 16 of the lid 15 from the electrode body connecting part 31. The second flange part 42 is extended in the horizonal direction from the tubular part 43 along the outer surface 17 of the lid 15. The second flange part 42 insulates the outer surface 17 of the lid 15 from the outside connecting part 33. The exterior shapes of the first flange part 41 and the second flange part 42 are larger than the exterior shapes of the electrode body connecting part 31 and the outside connecting part 33 of the terminal member 30. As shown in FIG. 3 and FIG. 4, the second flange part 42 is extended beyond the outside of the terminal member 30 (outside connecting part 33) in a planar view and exposed to the outside.

As shown in FIG. 2, the lid assembly 15A is an assembly part in which the terminal member 30 and the insulating member 40 are assembled to the lid 15 by insert molding (integral molding). In the lid assembly 15A, the terminal member 30 is not caulked, and fixed to the lid 15 by the insulating member 40. In addition, the terminal member 30 is fixed by the insulating member 40, and thus is fixed to the lid 15 without direct contact with the lid 15. A roughened surface part subjected to surface roughening treatment, for example, may be provided in the lid 15 and the terminal member 30, not shown. Because of this, the lid 15, the terminal member 30 and the insulating member 40 can be more firmly fixed.

### Method for Manufacturing Batteries

The manufacture method disclosed herein will now be described. The manufacture method includes at least a preparation step of preparing the outer case 11 and the lid assembly 15A; an attachment step of attaching the lid assembly 15A to the outer case 11; and a welding step of laser welding of the boundary between the opening 12 of the outer case 11 and the peripheral part of the lid 15. In the preparation step, the outer case 11 in which the peripheral part 12e of the opening 12 is a flat surface, and the lid assembly 15A including the lid 15 having the inclined part 15s are prepared. The lid assembly 15A is placed so that the inclined part 15s of the lid 15 will become thinner from the outer surface 17 toward the boundary with the outer case 11, and further the outer surface 17 of the lid 15 is placed at a higher place than the peripheral part 12e of the opening 12, and the inner surface 16 of the lid 15 is placed at a lower place than the peripheral part 12e of the opening 12. The manufacture method disclosed herein is characterized by performing the preparation step, the attachment step and the welding step as described above, and manufacture processes other than the above may be the same as conventional processes. Other steps may be further included in optional stages.

FIG. 5 is a longitudinal sectional view schematically showing the vicinity of the boundary of the outer case 11 and the lid 15 in the welding step. According to the manufacture method disclosed herein, irradiated laser light IL from the outer surface 17 side hits part of the lid 15 and part of the peripheral part 12e of the opening 12 as shown by the bold arrow in FIG. 5. The laser light IL hitting parts of the lid 15 and the peripheral part 12e of the opening 12 is reflected at the boundary, and the reflection light RL can be reflected outward as shown by the fine arrow in FIG. 5. Therefore, also when a region close to the insulating member 40 is welded, damages on the insulating member 40 can be suppressed. By using the outer case 11 in which the peripheral part 12e of the opening 12 is a flat surface, the area irradiated with the laser light IL is increased, and a stronger welded part 50 can be formed. According to such manufacture method, deterioration of the insulating member 40 is suppressed at the time of laser welding of the lid assembly obtained by integral molding of the lid 15, the terminal member 30 and the resin insulating member 40, and the outer case 11, and the battery 100 having high welding strength can be achieved.

In the preparation step, the outer case 11 and the lid assembly 15A are prepared. Other necessary members as described above are further prepared. As the outer case 11, a case in which the peripheral part 12e of the opening 12 is a flat surface is prepared. More specifically, the peripheral part 12e is a flat surface intersecting the thickness direction of the lid 15.

The lid 15 has an inclined part 15s, which is inclined to reduce the thickness of the lid 15 from the middle side toward the outer edge part 15e of the lid 15. The lid 15 has a flat part 15f on the inner side of the radial direction of the inclined part 15s (see FIG. 4). The average thickness of the lid 15 in the inclined part 15s is smaller than the average thickness of the lid 15 in the flat part 15f. When the lid 15 has the inclined part 15s, the irradiated laser light IL hits the inclined part 15s and flies to the opposite direction of the insulating member 40, and thus the insulating member 40 can be suitably prevented from the laser light.

When joined to the outer case 11 in the attachment step described below, the inclined part 15s has an inclined surface which is inclined from the outer surface 17 toward the boundary between the lid 15 and the outer case 11 at an inclination angle θ1. As shown in FIG. 4 for example, it is only needed that the inclined part 15s be inclined to become thinner as the distance from the insulating member 40 increases. The inclination angle θ1 is an inclination angle based on the outer surface 17 of the lid 15 (which is the same as the horizontal plane here). Specifically, the inclination angle θ1 is the smaller angle among angles formed by the extended line of the outer surface 17 of the lid 15 and the extended line of the inclined part 15s. In the inclined part 15s, the inclination angle θ1 is constant here.

The inclination angle θ1 is not particularly limited as long as it is an angle which can suitably reflect the laser light IL as described above. The inclination angle θ1 is at least 1° or more, preferably 5° or more, can be 10° or more and is more preferably 20° or more. The inclination angle θ1 is preferably 90° or less, for example 80° or less, and more preferably 60° or less. When the inclination angle θ1 is a predetermined value or more, the laser light IL is not easily reflected on the insulating member 40 side at the time of laser welding, and burns of the insulating member 40 can be suppressed at a higher level. When the inclination angle θ1 is a predetermined value or less, molten metal does not easily flow along the inclination at the time of laser welding, and welding properties can be improved.

The inclined part 15s is preferably provided on the outer surface 17 side in the thickness direction of the lid 15, but the present disclosure is not particularly limited thereto. When the maximum thickness t of the lid 15 (the length in the vertical direction Z, the same applies hereinafter) is 100%, specifically, the inclined part 15s is preferably provided in a region of 50% or less from the outer surface in the thickness direction, for example may be provided in a region of 40% or less. Because of this, the reflection light of the irradiated laser light from the upper side is suitably scattered, and the insulating member 40 can be protected. Meanwhile, it is preferred that the inclined part 15s not provided on the inner surface side in the thickness direction of the lid 15. That is, when the maximum thickness t of the lid 15 is 100%, it is preferred that the inclined part 15s not provided in a region of less than 50% from the inner surface in the thickness direction. The lid 15, for example, preferably has a surface parallel to the side wall of the outer case 11 (the long side wall 11b here) in a region of less than 50% from the inner surface in the thickness direction, in the longitudinal section along the thickness direction. Because of this, a gap between the lid 15 and the outer case 11 can be reduced. Therefore, for example, the direct entry of laser from the gap of the boundary between the lid 15 and the outer case 11 to the inside of the case, so-called “laser pass,” can be suitably suppressed.

The method for forming the inclined part 15s as described above is not particularly limited. The lid 15 having the inclined part 15s of a desired shape can be produced, for example, by cutting of the peripheral part of the lid 15. Alternatively, processing (coining) may be also performed by hitting the outer edge part from the oblique direction with jigs placed on the outer surface side of the lid and the outside of the side wall. At this time, metal (pads) can be transferred to the outer surface side and slightly expanded, and pads can flow to the downside (the inner surface side) of the side wall; however, the above can be accepted as long as the effect of the technique disclosed herein is not lost.

The preparation step can include an insert molding (integral molding) step. In the insert molding step, the terminal member 30 and the insulating member 40 are integrated with the lid 15 to produce an assembly part (e.g., lid assembly 15A). The lid assembly 15A can be produced by insert molding of the lid 15, the terminal member 30 and insulating member 40. Because of this, the number of parts can be reduced, and also a conductive path can be easily formed compared to conventional methods using rivets. The lid assembly 15A can be produced, for example, using molding dies having a lower die and an upper die by a method including a part set step, a positioning step, an upper die set step, an injection molding step, an upper die release step and a part stripping step.

In the part set step, two terminal members 30 are each inserted into the terminal attachment holes 18 of the lid 15, and the lid 15 is then put on the lower die. In the positioning step, the terminal members 30 are positioned and fixed. In the upper die set step, the upper die is put on so that the lid 15 and the terminal member 30 will be put between the upper die and the lower die in the vertical direction. In the injection molding step, first, molding dies are heated. Next, molten resin is injected into the molding dies. The molten resin is allowed to pass from the upper die through the terminal attachment hole 18 and to flow to the lower die. Subsequently, the molding dies and a molded product are cooled. Therefore, the insulating member 40, the lid 15 and the terminal member 30 are integrated. In the upper die release step, the upper die is separated from the lower die. In the part stripping step, the molded product is taken out of the lower die.

When the lid 15, the terminal member 30 and the insulating member 40 are integrated by insert molding, it is desired that the contact area of the lid 15 and the insulating member 40 be increased to raise adhesion. Because of this, the outside connecting part 33 and/or the second flange part 42 tend to be larger than conventional ones, and the insulating member 40 (more specifically the second flange part 42) and the welded site are easily close to each other on the outer surface 17 of the lid 15. Therefore, the application of the technique disclosed herein is particularly effective.

For example, when the lid 15 having an almost flat plate shape, and the outer case 11 are welded as shown, the outer edge part 15e of the lid 15 and the insulating member 40 are closest to each other in the regions A on both ends in the long side direction Y (see FIG. 4). Therefore, the lid 15 preferably has the inclined part 15s at least in the region A in the technique disclosed herein. Because of this, even when using the integrally molded lid assembly 15A, welding can be performed while suitably protecting the insulating member 40. The lid 15 preferably has at least the inclined part 15s in a region in which the distance between the outer edge part 15e of the lid 15 and the insulating member 40 is 3 mm or less (e.g., 2 mm or less), for example, at the time of welding. It is preferred that the inclined part 15s be continuously formed into an almost annular along the boundary of the outer case 11 and the lid 15. Because of this, the insulating member 40 can be more securely protected.

In the attachment step, the lid assembly 15A is attached to the opening 12 of the outer case 11. At this time, the lid assembly 15A is placed so that the thickness of the lid 15 in the inclined part 15s will become thinner toward the boundary with outer case 11 as shown in FIG. 4. The outer surface 17 of the lid 15 is placed at a higher place than the peripheral part 12e of the opening 12, and the inner surface 16 of the lid 15 is placed at a lower place than the peripheral part 12e of the opening 12. Because of this, the laser light IL suitably hits the inclined part 15s, and the laser light is easily reflected in a direction that moves away from the insulating member 40.

In the attachment step, the peripheral part 12e of the opening 12 is preferably placed in a region on the inner surface side in the thickness direction of the lid 15, but the present disclosure is not limited thereto. That is, when the maximum thickness of the lid 15 is 100%, the peripheral part 12e of the opening 12 is preferably placed in a region of less than 50% from the inner surface 16 in the thickness direction. The peripheral part 12e of the opening 12 is more preferably placed in a region of 25% or more and less than 50% from the inner surface 16 in the thickness direction. Alternatively, when the maximum thickness of the lid 15 is considered t, the distance from the peripheral part 12e to the inner surface 16 of the lid 15 relative to the maximum thickness t is preferably (t/4) to (t/2). Because of this, while displaying the protection effect of the inclined part 15s on the insulating member 40, the contact area of the lid 15 and the outer case 11 can be sufficiently secured, and welding properties can be improved. The laser pass can be also suitably prevented.

The distance between the outer surface 17 of the lid 15 and the peripheral part 12e of the opening 12 (the length in the vertical direction Z) varies depending on the size of the battery 100, the thickness of the lid 15, the thickness of the outer case 11 and the like. Therefore, the distance is not particularly limited, and is for example 0.05 mm or more and 0.6 mm or less, and preferably for example 0.05 mm or more and 0.1 mm or less.

The lid assembly 15A can be electrically connected to the electrode body 20 before being assembled with outer case 11, but the present disclosure is not particularly limited thereto. Specifically, the electrode body 20 is attached to the lid assembly 15A by electrically connecting the electrode body connecting part 31 of the terminal member 30 integrated with the lid 15, and the positive electrode tab 21t and the negative electrode tab 22t. The electrode body 20 attached to the lid assembly 15A is preferably covered with an electrode body holder (not shown), and then accommodated in the inside of the outer case 11. It is accommodated in the inside of the outer case 11 so that the winding axis direction WD of the electrode body 20 will be almost equal to the vertical direction Z here.

The method for placing the lid assembly 15A and the outer case 11 to a place as described above is not particularly limited. As shown in FIG. 4, for example, the supporting part 11e may be provided on the inner wall 11d of the outer case 11 so that the lid 15 will be placed to a desired place. Because of this, the lid 15 can be placed at a desired place by an easy method. Alternatively, the placement of the lid 15 connected to the electrode body 20 may be adjusted by increasing the height of the electrode body 20 (the length in the vertical direction Z, the same applies hereinafter), or the placement of the lid 15 may be adjusted by increasing the thickness of the lid 15.

In the welding step, the outer case 11 and the lid assembly 15A are laser-welded by irradiating the boundary between the outer case 11 and the lid assembly 15A (more specifically the lid 15) with laser light after the electrode body 20 is accommodated in the inside of the case 10. Because of this, the welded part 50 is formed on the boundary between the outer case 11 and the lid 15.

As shown in FIG. 5, the boundary between the outer case 11 and the lid 15 is irradiated with laser light IL from the outer surface side of the outer case 11 in the manufacture method disclosed herein. The angle by the laser irradiation direction and the outer surface 17 (horizontal plane) of the lid 15 is not particularly limited, and is preferably for example about 90±10°, and may be about 90±5°. It should be noted that the kind of laser light and the conditions of laser welding may be the same as in methods for laser welding, which are used for batteries of this type, and are not particularly limited.

As shown by the bold arrow in FIG. 5, the irradiated laser light IL from the outer surface side hits part of the lid 15 and part of the peripheral part 12e of the opening 12. The reflection light RL of the laser light IL is not easily reflected in the direction of the insulating member 40. In the manufacture method disclosed herein, the lid 15 has the inclined part 15s, and moreover the outer surface 17 of the lid 15 is placed higher than the peripheral part 12e of the opening 12, and the inner surface 16 is placed lower than the peripheral part 12e of the opening 12. Therefore, it is suggested that from a relationship between the incidence angle and the reflection angle, the laser light IL easily hits the inclined part 15s, and the laser light IL is reflected in a direction that moves away from the insulating member 40. In addition, the diffusion light DL of the irradiated laser light IL can be slightly reflected toward the inclined part 15s; however, because the light hits the inclined part 15s, the light is reflected again in the opposite direction to the insulating member 40. That is, according to the technique disclosed herein, the insulating member 40 can be also protected from secondary reflection light (e.g., diffusion light) generated in the vicinity of the opening 12. Therefore, even when the welded site and the insulating member 40 are close to each other, deterioration of the insulating member is suitably suppressed.

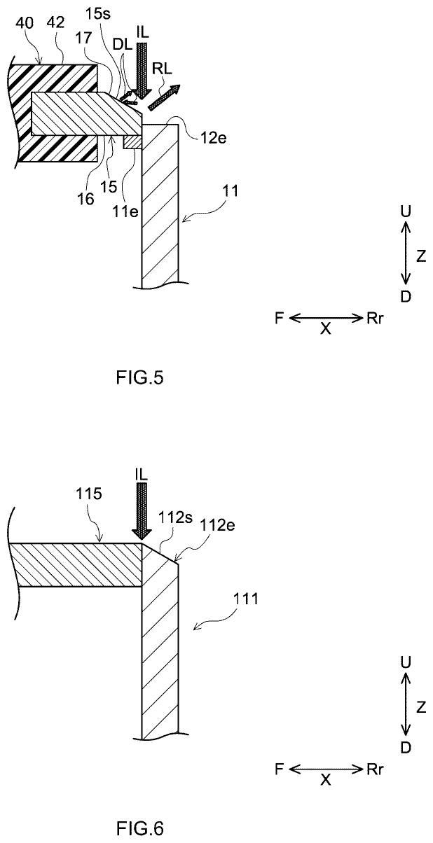

FIG. 6 is a longitudinal sectional view describing a conventional welding step for batteries. As shown in FIG. 6, when a peripheral part 112e of an opening in an outer case 111 has an inclined part 112s, part of the inclined part 112s and part of a lid 115 are irradiated with laser light IL (that is, receiving the laser light at points). Therefore, the amount of metal melted in the conventional technique shown in FIG. 6 is small, and the welding strength is reduced. As shown in FIG. 5, meanwhile, the peripheral part 12e of the opening 12 is a flat surface, the inclined part 15s is provided in the lid 15, and the outer surface 17 is placed higher than the peripheral part 12e in the manufacture method disclosed herein. Because of this, part of the inclined part 15s and part of the peripheral part 12e are irradiated with the laser light IL (that is, receiving the laser light on a surface). Therefore, the amount of metal melted is high, and welding strength can be raised. Because of these, at the time of the laser welding of the lid assembly 15A obtained by integral molding of the lid 15 having the terminal attachment hole 18, the terminal member 30 and the resin insulating member 40, and the outer case 11, deterioration of the insulating member 40 is suppressed, and the battery 100 having high welding strength can be achieved.

### Uses of Batteries

The battery manufactured by the manufacture method disclosed herein can be employed for various uses, and can be suitably used, for example, as power sources for motors (driving power supply) mounted on vehicles such as cars and trucks. The kind of vehicle is not particularly limited, and examples thereof include plug-in hybrid electric vehicles (PHEV), hybrid electric vehicles (HEV), battery electric vehicles (BEV) and the like. The battery can be also suitably used to assemble an assembled battery.

As described above, some embodiments of the present disclosure have been described; however, the embodiments are merely examples. The present disclosure can be implemented in other various forms. The present disclosure can be implemented based on the contents disclosed in the specification and technical knowledge in the art. Various variants and modifications of the embodiments described above as examples are encompassed in the technique described in claims. For example, part of the embodiments can be also replaced with another variant aspect, and another variant aspect can be also added to the embodiments. In addition, when technical features are not described as essential, they can be properly removed.

As described above, as specific aspects of the technique disclosed herein, those described in the following items are provided.

Item 1: a method for manufacturing an electrical storage device, including a case including an outer case having an opening on one side surface and the bottom, and a lid having terminal attachment holes and sealing the opening; an electrode body accommodated in the case; a terminal member, having an one end electrically connected to the electrode body in the inside of the case, and the other end exposed to the outside of the lid; and a resin insulating member, which insulates a surface of the lid, which is the outer surface on the outside of the case, the opening of which is sealed, from the terminal member: the method including a step of preparing the outer case in which a peripheral part of the opening is a flat surface, and a lid assembly, wherein the lid assembly is obtained by integral molding of the lid, the terminal member and the insulating member; a step of attaching the lid assembly to the opening of the outer case; and a step of laser welding of the outer case and the lid assembly by irradiating the boundary between the peripheral part of the opening and the outer edge part of the lid with laser light from the outer surface side of the lid; wherein the lid prepared in the preparation step has an inclined part, which becomes thinner from the middle side toward the outer edge part of the lid, in a region in which the outer edge part of the lid and the insulating member are closest to each other; the lid assembly is placed so that the inclined part will become thinner from the outer surface toward the boundary with the outer case in the attachment step; and the outer surface of the lid is placed at a higher place than the peripheral part of the opening, and the inner surface of the lid is placed at a lower place than the peripheral part of the opening.

Item 2: the manufacture method according to Item 1, wherein the outer case prepared in the preparation step has a rectangular opening, a rectangular bottom surface facing the opening, a pair of first side walls extended from the bottom surface and facing each other, and a pair of second side walls extended from the bottom surface and facing each other, the lid assembly prepared in the preparation step has a rectangular lid, and the inclined part is provided to span the whole circumference of the outer edge part of the lid.

Item 3: the manufacture method according to Item 1 or 2, wherein when the maximum thickness of the lid is 100%, the lid assembly prepared in the preparation step has the inclined part in a region of 50% or less from the outer surface in the thickness direction.

Item 4: the manufacture method according to any one of Items 1 to 3, wherein when the maximum thickness of the lid is 100%, the peripheral part of the opening is placed in a region of 25% or more and less than 50% from the inner surface in the thickness direction in the attachment step.

What is claimed is:

1. A method for manufacturing an electrical storage device, comprising,
a case, comprising an outer case having an opening on one side surface and a bottom, and a lid having terminal attachment holes and sealing the opening,
an electrode body accommodated in the case,
a terminal member, having an one end electrically connected to the electrode body in an inside of the case, and the other end exposed to an outside of the lid, and
a resin insulating member, which insulates a surface of the lid, which is an outer surface on an outside of the case, the opening of which is sealed, from the terminal member,
the method comprising,
a step of preparing the outer case in which a peripheral part of the opening is a flat surface, and a lid assembly, wherein the lid assembly is obtained by integral molding of the lid, the terminal member and the insulating member;
a step of attaching the lid assembly to the opening of the outer case; and
a step of laser welding of the outer case and the lid assembly by irradiating a boundary between the peripheral part of the opening and an outer edge part of the lid with laser light from an outer surface side of the lid;
wherein the lid prepared in the preparation step has an inclined part, which becomes thinner from a middle side toward the outer edge part of the lid, in a region in which the outer edge part of the lid and the insulating member are closest to each other,
the lid assembly is placed so that the inclined part will become thinner from the outer surface toward a boundary with the outer case in the attachment step, and
an outer surface of the lid is placed at a higher place than the peripheral part of the opening, and an inner surface of the lid is placed at a lower place than the peripheral part of the opening.

2. The manufacture method according to claim 1,
wherein the outer case prepared in the preparation step has a rectangular opening, a rectangular bottom surface facing the opening, a pair of first side walls extended from the bottom surface and facing each other, and a pair of second side walls extended from the bottom surface and facing each other,
the lid assembly prepared in the preparation step has a rectangular lid, and the inclined part is provided to span a whole circumference of the outer edge part of the lid.

3. The manufacture method according to claim 1, wherein when a maximum thickness of the lid is 100%, the lid assembly prepared in the preparation step has the inclined part in a region of 50% or less from the outer surface in a thickness direction.

4. The manufacture method according to claim 1, wherein when the maximum thickness of the lid is 100%, the peripheral part of the opening is placed in a region of 25% or more and less than 50% from the inner surface in a thickness direction in the attachment step.
